(19) United States
(12) Patent Application Publication
(10) Pub. No.: US 2010/0162143 A1
(43) Pub. Date: Jun. 24, 2010

(54) SYSTEMS AND METHODS FOR BUSINESS DRIVEN APPLICATION DEVELOPMENT

(76) Inventors: Moshe Ben Abou, Tel-Aviv (IL); Asaf Carmel, Hertzlia (IL); Michal Zmiri-Yaniv, Hertalia (IL)

Correspondence Address: SAP AG c/o BUCKLEY, MASCHOFF & TALWALKAR LLC, 50 LOCUST AVENUE, NEW CANAAN, CT, 06840, US

(21) Appl. No.: 12/341,707

(22) Filed: Dec. 22, 2008

(51) Int. Cl. G06F 3/00

(52) U.S. Cl. 715/762

(57) ABSTRACT

According to some embodiments, business process definition information is received from a business analyst via a high-level design board interface. The business process definition information may, for example, include graphical components. The business process definition information may then be directly translated, at a solution engine, to automatically generate a user interface application. The user interface application may, for example, include a plurality of user interface screens and associated flow logic between the user interface screens.

### FIELD

Some embodiments of the present invention may relate to the development of user interface applications. In particular, some embodiments may comprise systems and methods that provide for business driven application development environment.

### BACKGROUND

A client may want to provide an interface that can be accessed by users for business purposes. For example, an enterprise that sells airline tickets might want provide such an interface to let users view available flights, reserve seats, and/or purchase tickets via a web interface. Often, a business analyst may be familiar with the ways in which the client would like the user interface to operate. The business analyst, however, is generally not able to write and/or modify the various software components that would be required to support the user interface.

A user interface designer and/or software developer may be able to write and/or modify the various software components associated with such a user interface application. As a result, the business analyst, user interface designer, and/or software developer may try to work together to create a user interface that satisfies the client's needs (as well as the needs of users). The communication between these parties, however, may be less then perfect. For example, the business analyst may wish that a user will be able to select an element from a first user interface screen and, as a result, be presented with a second user interface screen that displays particular items of information in a particular format. This wish, however, might be misunderstood by the user interface designer and/or software developer and, as a result, the generated user interface application may not operate in an appropriate manner.

Approaches that improve the process of designing a user interface application could, therefore, be desirable. Moreover, it may advantageous to provide one or more systems and/or methods to do so in a more efficient and convenient manner as compared to typical systems.

### BRIEF DESCRIPTION OF THE DRAWINGS

FIG. 1 is a block diagram of a typical system to facilitate development of a user interface application.

FIG. 2 is a block diagram of a system according to some embodiments of the present invention.

FIG. 3 illustrates a method according to some embodiments of the present invention.

FIG. 4 is a process overview of a user interface design time system according to some embodiments.

FIG. 5 is an example of a process definition scenario that may be associated with a high-level design board in accordance with some of the embodiments described herein.

FIG. 6 illustrates the use of an item selection visual template in connection with a data flow design board according to some embodiments of the present invention.

FIG. 7 illustrates an apparatus in accordance with some embodiments of the present invention.

FIG. 8 is one example of a layout editor design board according to some embodiments of the present invention.

### DETAILED DESCRIPTION

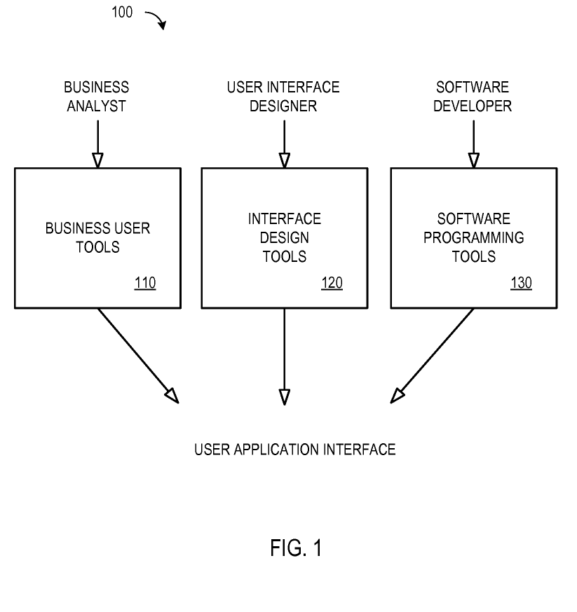

A client may want to provide an interface that can be accessed by users for business purposes. For example, an enterprise that sells shares of publicly traded stocks provide such an interface to let users view information about various stocks (e.g., current and historical pricing information) and/or purchase shares of stocks via a web interface. FIG. 1 is a block diagram of a typical system 100 that may be used to facilitate development of a user interface application.

Often, a business analyst may be familiar with the ways in which the client would like the user interface to operate. The business analyst, however, is generally unable to write and/or modify the various software components that would be required to support the user interface. Instead, the business analyst might provide information about a customer's requirements through business user tools 110. For example, the business analyst might describe how a finished user interface should operate using Microsoft Word®, Excel®, PowerPoint®, and similar types of tools.

A user interface designer might utilize the information provided by the business analyst to generate and/or modify software components associated with the user interface application via interface design tools 120 (e.g., the user interface designer, such as a graphics designer, might customize display “skins” and/or the layout of data elements in user interface screens). Similarly, a software developer might utilize the information provided by the business analyst to generate and/or modify software components via software programming tools 130 (e.g., the software developer might create custom-made components to support the user interface application).

The business analyst, user interface designer, and/or software developer may thus to work together to create a user interface that satisfies the client's needs (as well as the needs of users). The communication between these parties, however, may be less then perfect. For example, the business analyst may wish that a user will be able to select an element from a first user interface screen and, as a result, be presented with a second user interface screen that displays particular items of information in a particular format. This wish, however, might be misunderstood by the user interface designer and/or software developer and, as a result, the generated user interface application may not operate in an appropriate manner. Note that such parties will often use different terms and descriptions even when referring to the same user interface items and interactions.

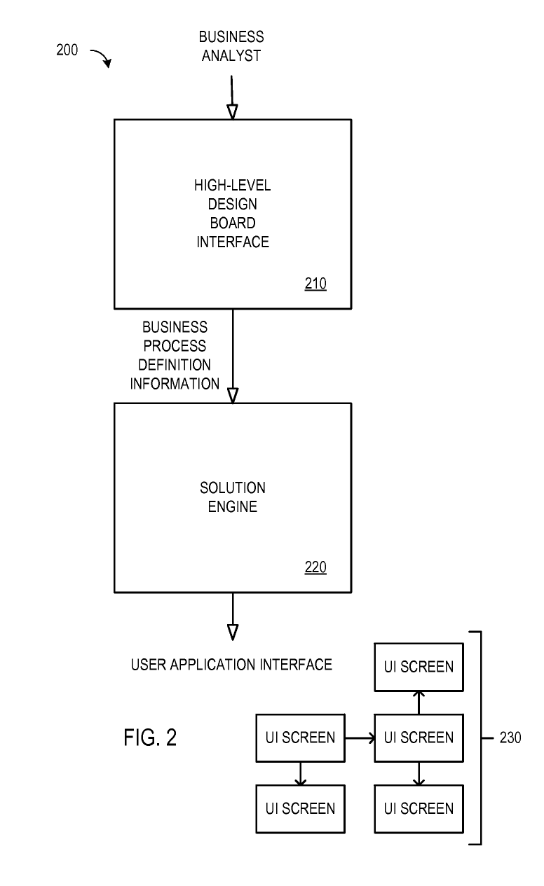

To help avoid such results, FIG. 2 is a block diagram of a system 200 according to some embodiments of the present invention. In particular, a business analyst may interact with a high-level design board interface 210 to provide business process definition information to a solution engine 220. Although a single high-level design board interface 210 and solution engine 220 are shown in FIG. 2 by way of example, note that any number of these elements (as well as the other elements described herein) may be provided in accordance with the embodiments described herein.

Further note that the high-level design board interface 210 and the solution engine 220 (as well as any other elements described herein) may exchange information via one or more interfaces (e.g., a local interface connection or a communication network interface). Moreover, elements described herein as communicating with one another may be directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Still further, communication between devices and/or systems may proceed over any one or more transmission protocols that are or become known, such as Asynchronous Transfer Mode (ATM), Internet Protocol (IP), Hypertext Transfer Protocol (HTTP), and/or Wireless Application Protocol (WAP).

Note that some or all of the devices illustrated in FIG. 2 (as well as the other systems described herein) may use processor-executable program code read from one or more of a computer-readable medium, such as a floppy disk, a CD-ROM, a DVD-ROM, a magnetic tape, and a signal encoding the process, and then stored in a compressed, uncompiled and/or encrypted format. Note that embodiments are not limited to any specific combination of hardware and software. Moreover, the devices described herein might, for example, support any of the protocols in the following non-exhaustive list: Java Database Connectivity (JDBC), Java Connector (JCO), P4, and Simple Object Access Protocol (SOAP). Moreover, the databases might comprise a relational database accessible via a Structured Query Language (SQL) interface and/or systems which provide intermediary “business intelligence” to data stored within the database.

The high-level design board interface 210 and/or the solution engine 220 might be associated with, for example, a server, a workstation, a Personal Computer (PC), or a mobile wireless device, such as a laptop computer, a Personal Digital Assistant (PDA), a tablet computer, a handheld computer, or any other suitable devices that are or become known.

The system 200 may help convert the information provided by the business analyst into an appropriate user application interface 230, including, for example, User Interface (UI) screens and flow logic between those screens, in accordance with any of the embodiments described herein. Note that the information provided by the business analyst may help define user interface screens and flow logic based on user events (e.g., a user selection of an icon or user-entered data). Moreover, by using a single design time tool, the user interface process may be changed without needing to perform coding tasks (which may be unfamiliar to someone such as a business analyst) within the tool, including customizations of forms, screens, and/or reports associated with a client system.

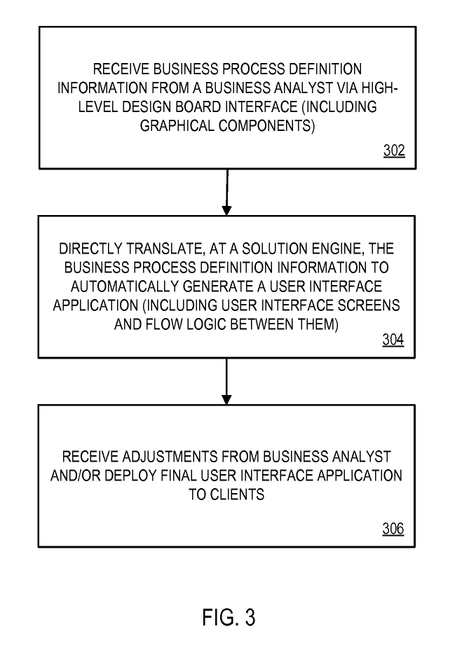

For example, FIG. 3 illustrates a method that might be associated with, for example, the system 200 of FIG. 2 pursuant to some embodiments. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 302, business process definition information may be received from a business analyst via a high-level design board interface, the business process definition information including graphical components. For example, the business analyst might be associated with an independent software vendor or a value added re-seller of software. Moreover, the business process definition information may include business scenario flow parameters and the high-level design board interface might include a graphical interface (used by the business analyst) to define the business scenario flow parameters based on customer requirements. According to some embodiments, at least some of the graphical components associated with the high-level design board interface include visual template components and/or re-usable components accessed via a library. Note that, as used herein, a “re-usable component” might refer to a composition of user interface elements (along with a definition of their layout and behavior) and a “visual template” might refer to an abstract component that describes user interface logic and data/user interface relations. These may be considered “building blocks” that can be used to ultimately create a user interface application.

At 304, the business process definition information may be directly translated at a solution engine to automatically generate a user interface application, the user interface application including a plurality of user interface screens and associated flow logic between the user interface screens. For example, the associated flow logic might include one or more conditions associated with a transition from a first user interface screen to a second user interface screen. Moreover, generation of the user interface application may further be facilitated by a data flow design board (e.g., providing meta-data item mapping and action information for a visual template component) and/or a layout editor design board providing layout and content information for a visual template component. Note that a visual template might comprise a starting point for screen development and/or facilitate a supply of meta-data for application development.

According to some embodiments, adjustments to the user interface application are received (e.g., from the business analyst) at 306. For example, the business might review a proposed user interface application and decide to insert additional content into at least one of the plurality of user interface screens. Similarly, the business analyst might adjust flow logic between some of the user interface screens. A final version of the user interface application may then be deployed to clients at 306.

According to some embodiments, the user interface application is further based on information defined via a data flow editor. For example, such a data flow editor might adapted to utilize .net code segments. Moreover, in some embodiments, the user interface application is further based on information defined via a domain-specific language technology, or a Windows Presentation Foundation (WPF) layout editor.

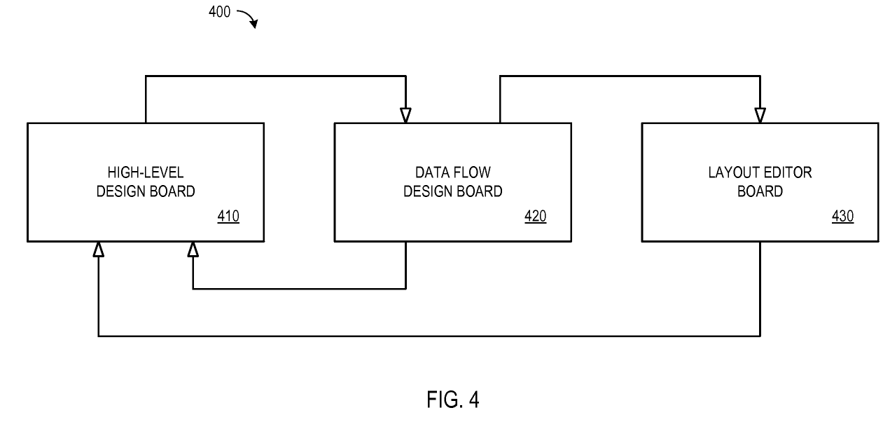

FIG. 4 is a process overview of a user interface design time system 400 according to some embodiments. In particular, a high-level design board 410 may provide information to a data flow design board 420. The high-level design board 410 might be associated with, for example, a business process description and/or may consume one or more visual templates. According to some embodiments, the high-level design board helps provide a developer with a high level description of a business process via visual language and/or visual templates.

The data flow design board 420 may, for example, be associated with user interface screen login and data/user interface interactions (e.g., to help a developer user interface logic and relations). The data flow design board 420 may also be associated with the creation of visual templates (e.g., to be consumed by the high-level design board 410) and/or re-usable components according to some embodiments. According to some embodiments, the data flow design board 420 will let a developer create or modify a user interface process by re-configuring connections be user interface elements and data elements (e.g., with little or no need for coding). For example, the data flow design board 420 may provide for the creation of user custom controls which will be consumed both in the data flow and a layout editor board 430.

The layout editor board 430 might provide for screen layout design and/or help layout visual templates and/or re-usable components. According to some embodiments, the layout editor board 430 is associated with a WPF layout editor designed to support custom controls and features using, for example, Visual Studios® 2008 graphics and layout capabilities. For example, in the layout editor board 430 (and, according to some embodiments, also in the data flow design board 420) a developer might be able to insert a custom code intervention just by dragging a required element from a toolbox. Note that, according to some embodiments, the data flow design board 420 and/or layout editor board 430 may also provide information back to the high-level design board 410.

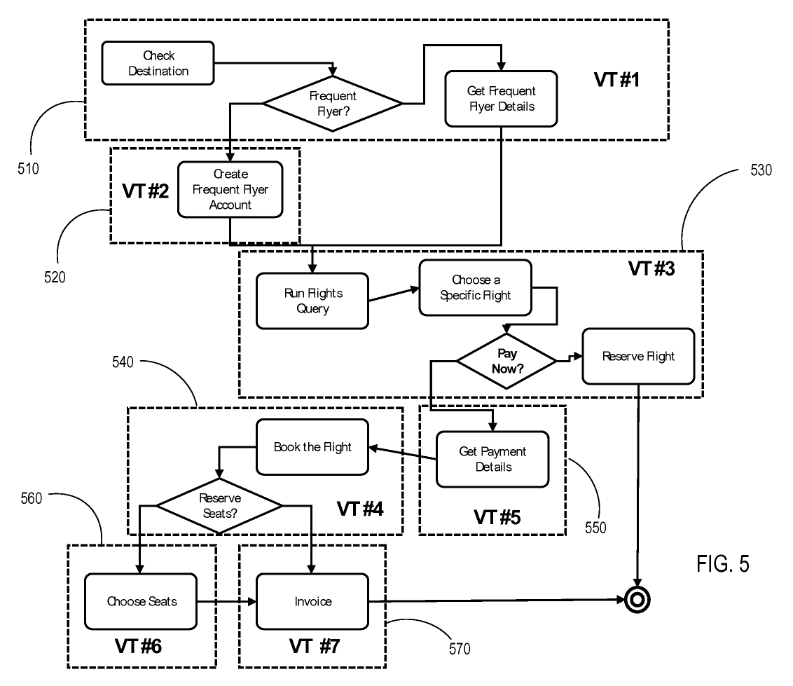

FIG. 5 is an example of a process definition scenario that may be associated with a high-level design board in accordance with some of the embodiments described herein. In particular, the example is associated with a user interface to allow for the purchase of a ticket for an airline flight that a business analyst might define via a high-level design board.

According to this example, the business analyst may use Visual Template (VT) 1 to help a user select a destination for the flight. Moreover, the business analyst may use VT 2 to let the user create an account (if needed) and VT3 to select an item (e.g., by generating queries about flights and then selecting a particular flight of interest). VT3 might also let the user reserve his or her flight.

To facilitate payment for the ticket, the business analyst might use VT5 to receive payment details (e.g., a credit card number and expiration date), VT4 to book the flight, and VT6 to let the user select his or her seats. Finally, the business analyst might use VT7 to generate and transmit invoice information as appropriate. Note that some or all of the visual templates and interactions between the templates might be customized and/or combined by the business analyst in a graphical manner (e.g., by connecting graphical elements via the high-level design board).

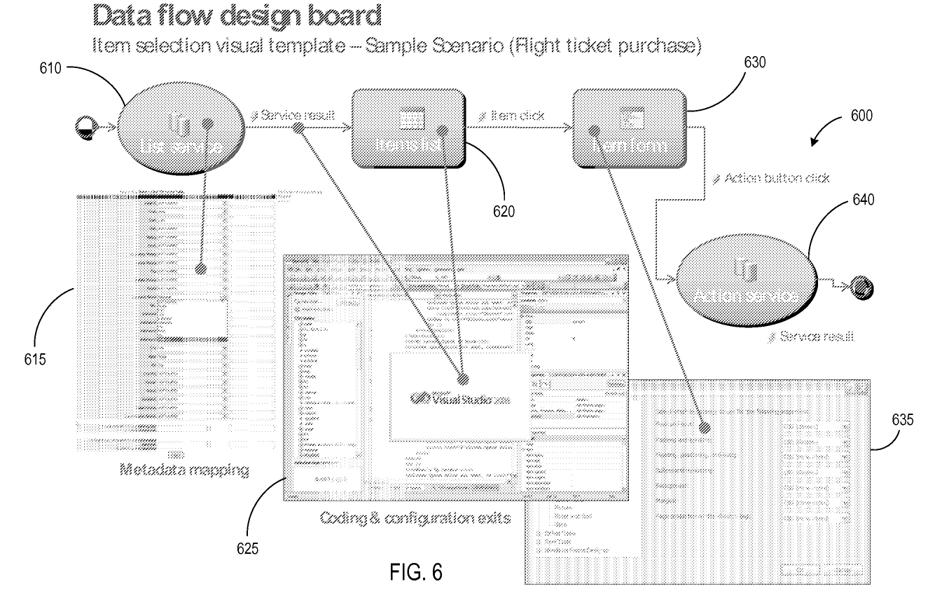

FIG. 6 illustrates the use 600 of an item selection visual template in connection with a data flow design board according to some embodiments of the present invention. The description of the data flow design board may be associated with, for example, the example of a ticket purchasing scenario described in connection with FIG. 5.

Initially, a list service 610 may provide a service result to an items list 620. Note that this may be associated with a meta-data mapping interface 615 in connection with one or more services. The item list 620 might indicate when a particular item has been selected (e.g., via an item click signal) to an item form 630. According to some embodiments, the service result and/or the items list 620 may be associated with coding and configuration exit parameter interface 625 (e.g., via Visual Studio® 2008). The item form 630 may provide an action button click to an action service 640.

According to some embodiments, the item form 630 may be associated with an interface 635 may be used, for example, to select technologies to be associated with various properties (e.g., to select that a background should be associated with cascading style sheet properties). Finally, the action service 640 might generate and output a service result (e.g., associated with the purchase of an airline ticket). In this way, a business analyst may use building blocks to create a full user interface application, including (1) screens which may be provided by a graphic designer and (2) code behind screens which may be provided by software developers. Moreover, modeling notation may be used to describe high level user interface application processes.

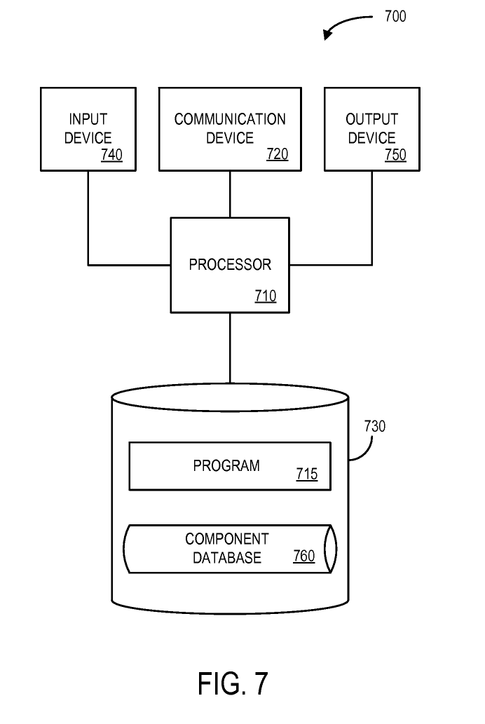

FIG. 7 illustrates an apparatus 700 in accordance with some embodiments of the present invention. The apparatus 700 might, for example, be associated with a PC or server that includes a processor 710, such as one or more INTEL® Pentium® processors, coupled to a communication device 720 configured to communicate via a communication network (not shown in FIG. 7). The communication device 720 may be used to exchange information, for example, with one or more remote systems including a high-level design board interface 210 and/or a solution engine 220. Note that elements described herein as communicating with one another may be directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between devices and/or systems may proceed over any one or more transmission protocols that are or become known, such as Asynchronous Transfer Mode (ATM), Internet Protocol (IP), Hypertext Transfer Protocol (HTTP), and/or Wireless Application Protocol (WAP).

The processor 710 is also in communication with an input device 740. The input device 740 may comprise, for example, a keyboard, a mouse, or computer media reader. Such an input device 740 may be used, for example, to enter information about user interface screens and/or flow logic between those screens. The processor 710 is also in communication with an output device 750. The output device 750 may comprise, for example, a display screen or printer. Such an output device 750 may be used, for example, to provide information about user interface application that are being constructed or that have been previously completed in connection with embodiments of the present invention described herein.

The processor 710 is also in communication with a storage device 730. The storage device 730 may comprise any appropriate information storage device, including combinations of magnetic storage devices (e.g., hard disk drives), optical storage devices, and/or semiconductor memory devices such as Random Access Memory (RAM) devices and Read Only Memory (ROM) devices.

The storage device 730 might store a component database 760 (e.g., a local database or a connection to an external source or library of visual templates and/or re-usable components) along with a program 715 for controlling the processor 710. The processor 710 performs instructions of the program 715, and thereby operates in accordance any embodiments of the present invention described herein. For example, the processor 710 may arrange (i) for a graphical business analyst interface to interact with a business analyst and (ii) to output business process definition information, the business process definition information including graphical components. The processor 710 may also be associated with a solution engine, coupled to a graphical business analyst interface, that receives the business process definition information and automatically generates a user interface application. The user interface application may, for example, include a plurality of user interface screens and associated flow logic between the user interface screens.

As used herein, information may be “received” by or “transmitted” to, for example: (i) the apparatus 700 from other devices; or (ii) a software application or module within the apparatus 700 from another software application, module, or any other source.

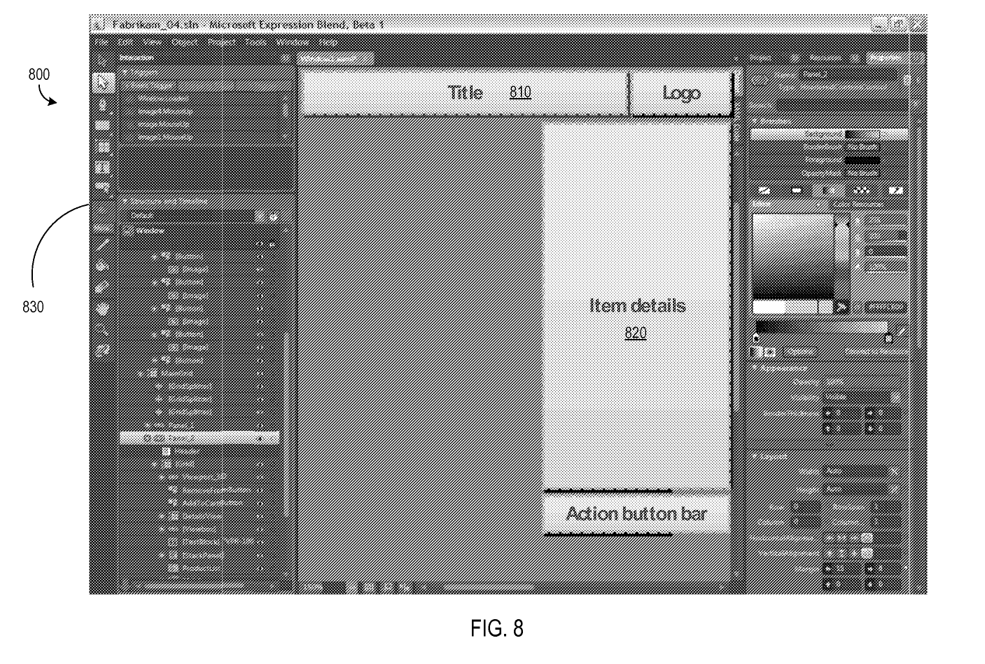

FIG. 8 is one example of a layout editor design board 800 according to some embodiments of the present invention. The layout editor design board 800 might be associated with, for example, item selection for a visual template in connection with the ticket purchasing scenario described in connection with FIGS. 5 and 6. According to some embodiments, the layout editor design board 800 is associated with Visual Studios® 2008. Note that the layout editor design board 800 illustrated in FIG. 8 may further be associated with the Microsoft® Expression Blend application®.

The layout editor design board 800 may let a title 810 and item details 820 be added to the design. Note that other elements (e.g., a client's logo and one or more action button bars) might also be provided for the design. In addition the layout editor design board 800 may include areas associated with the selection or definition of: user interactions, structures and timelines for the interface, graphical appearance parameters (e.g., size, color, and positioning information associated with the user interface), and/or Extensible Application Markup Language (XAML) data.

Thus, embodiments may provide for improved processes for designing a user interface application. Moreover, the systems and/or methods described herein may do so in a more efficient and convenient manner as compared to typical systems. In addition, the user interface design time concept may improve the way developers and partners (such as independent software vendors or value added re-sellers) approach the processes of application development and enhancements and provide capabilities needed to create highly rich desktop applications without coding (e.g., through the use of graphic elements).

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although embodiments have been described as being used to implement user interface application for specific types of clients, not that embodiments may be associated with any other type of enterprise that needs to provide user interactions (including users who are customers, employees, etc.). Moreover, as used herein a “business analyst” may refer to any person interested in creating a user interface application (e.g., and who may be unfamiliar with interface design and/or software programming tools).

The several embodiments described herein are solely for the purpose of illustration. Persons skilled in the art will recognize from this description other embodiments may be practiced with modifications and alterations limited only by the claims.

What is claimed is:

1. A method to facilitate design of a user interface, comprising:
receiving business process definition information from a business analyst via a high-level design board interface, the business process definition information including graphical components; and
directly translating, at a solution engine, the business process definition information received from the high-level design board interface to automatically generate a user interface application, the user interface application including a plurality of user interface screens and associated flow logic between the user interface screens.

2. The method of claim 1, wherein the graphical components associated with the high-level design board interface include at least one of: (i) visual template components, or (ii) re-usable components accessed via a library.

3. The method of claim 2, wherein generation of the user interface application is further facilitated by at least one of: (i) a data flow design board providing meta-data item mapping and action information for a visual template component, or (ii) a layout editor design board providing layout and content information for a visual template component.

4. The method of claim 1, wherein the business process definition information includes business scenario flow parameters.

5. The method of claim 4, wherein the high-level design board interface comprises a graphical interface used by the business analyst to define the business scenario flow parameters based on customer requirements.

6. The method of claim 1, further comprising:
receiving adjustments to the user interface application from the business analyst.

7. The method of claim 6, wherein the adjustments include additional content to be added to at least one of the plurality of user interface screens.

8. The method of claim 1, where the associated flow logic includes conditions associated with a transition from a first user interface screen to a second user interface screen.

9. The method of claim 1, wherein the business analyst is associated with at least one of: (i) an independent software vendor, or (ii) a value added re-seller of software.

10. The method of claim 1, wherein the user interface application is further based on information defined via a data flow editor.

11. The method of claim 10, wherein the data flow editor is adapted to utilize .net code segments.

12. The method of claim 1, wherein the user interface application is further based on information defined via at least one of: (i) a domain-specific language technology, or (ii) a Windows presentation foundation layout editor.

13. A system, comprising:
a graphical business analyst interface to interact with a business analyst and to output business process definition information, the business process definition information including graphical components; and
a solution engine, coupled to the graphical business analyst interface, to receive the business process definition information and to automatically generate a user interface application, the user interface application including a plurality of user interface screens and associated flow logic between the user interface screens.

14. The system of claim 13, further comprising:
a database to store graphical components associated with the graphical business analyst interface, the graphical elements including at least one of: (i) visual template components, or (ii) re-usable components accessed via a library.

15. The system of claim 13, wherein generation of the user interface application is further facilitated by at least one of: (i) a data flow design board providing meta-data item mapping and action information for a visual template component, or (ii) a layout editor design board providing layout and content information for a visual template component.

16. The system of claim 13, wherein the solution engine is further to process adjustments to the user interface application.

17. The system of claim 13, wherein the adjustments include additional content to be added to at least one of the plurality of user interface screens.

18. A computer-readable medium storing processor-executable process steps that, when executed by a processor, perform a method, wherein the method comprises:
receiving business process definition information from a business analyst via a high-level design board interface, the business process definition information including graphical components; and
directly translating, at a solution engine, the business process definition information received from the high-level design board interface to automatically generate a user interface application, the user interface application including a plurality of user interface screens and associated flow logic between the user interface screens.

19. The computer-readable medium of claim 18, wherein the graphical components associated with the high-level design board interface include at least one of: (i) visual template components, or (ii) re-usable components accessed via a library.

20. The computer-readable medium of claim 18, wherein generation of the user interface application is further facilitated by at least one of: (i) a data flow design board providing meta-data item mapping and action information for a visual template component, or (ii) a layout editor design board providing layout and content information for a visual template component.

21. The computer-readable medium of claim 18, wherein the business process definition information includes business scenario flow parameters.
